(19) United States
(12) Patent Application Publication
(10) Pub. No.: US 2025/0091795 A1
(43) Pub. Date: Mar. 20, 2025

(54) SYSTEMS AND METHODS FOR STORAGE OF SANITARY USE ARTICLES

(71) Applicant: Christopher Matysek, Barrington, IL (US)

(72) Inventor: Christopher Matysek, Barrington, IL (US)

(21) Appl. No.: 18/970,760

(22) Filed: Dec. 5, 2024

Related U.S. Application Data
(63) Continuation-in-part of application No. 17/530,417, filed on Nov. 18, 2021.
(60) Provisional application No. 63/116,429, filed on Nov. 20, 2020.

(51) Int. Cl. B65D 83/08; B65D 33/00; B65D 33/14; B65D 33/24; B65D 65/40; B65D 85/18

(52) U.S. Cl. CPC B65D 83/0805; B65D 33/004; B65D 33/14; B65D 33/24; B65D 65/40; B65D 85/18; B65D 2565/387

(57) ABSTRACT

A storage pouch for sanitary use articles, such as gloves, includes a front panel and a rear panel joined along at least a portion of their respective perimeters to define an interior space. A flap portion extends from the rear panel and is configured to fold over the front panel, forming a substantially impervious enclosure to safeguard the pouch's contents from external contaminants. The pouch may include a dispensing slot for removing sanitary articles, optionally covered by a resealable access strip, and an attachment mechanism, such as an adhesive patch, to secure the pouch to an inner surface of an automobile's fuel or electric charging access compartment. The pouch may further include multi-layer construction, activated charcoal filters, or desiccant packets to enhance protection against environmental contaminants. The pouch facilitates convenient and sanitary handling of potentially contaminated surfaces.

### CROSS REFERENCE TO RELATED APPLICATIONS

Continuation-in-Part of U.S. patent application Ser. No. 17/530,417 filed on Nov. 18, 2021, which claims priority to and the benefit under 35 USC § 119 (e) of U.S. Provisional Patent Application No. 63/116,429 filed on Nov. 20, 2020. The contents of both aforesaid applications are incorporated by reference in their entirety as if fully set forth herein.

### TECHNICAL FIELD

This disclosure relates to systems and methods for storing sanitary use articles. In particular, this disclosure relates to systems and methods for storing sanitary use articles such as gloves within an automobile compartment. Most particularly, this disclosure relates to a pouch for containing gloves, wherein the pouch is configured to be concealably stored within the refueling access enclosure of an automobile.

### BACKGROUND

Surfaces are known to harbor germs such as bacteria and viruses that can contribute to the spread of disease among humans. Certain surfaces are more likely to harbor germs than others by, for example, providing an environment that protects or fosters proliferation of germs. For example, it is generally well-known that dish sponges can carry and foster growth of bacteria by providing a moist environment and nutrients. However, germs can survive on surfaces far less hospitable, such as keyboards, cell phones and remote controls. Each of these types of surfaces, which are often touched by more than one person, can contribute to the spread of disease unless they are continually washed and/or sanitized.

One surface that has been identified as a potential disease-spreading vector is fuel pump handles and buttons. Across the world, fuel pump handles are used by many people to fuel automobiles and other modes of transportation. As is generally known, those wishing to fuel their vehicles use their hands to grab the pump handle, insert the pump nozzle into the fuel port of the automobile, and use their fingers to actuate the pump handle. Thus, a fuel pump handle can come into contact with a person's palm and fingers, typically the pads of the fingers, which are known to be areas of the human body that carry and transmit viruses and bacteria. When fueling is complete, the person typically grabs the handle again to replace it. Subsequently, the next person to fuel their vehicle performs the same process, inviting the spread of germs. In many, if not most cases, fuel handles are not sanitized between uses which contributes to the spread of disease.

In some areas of the world, so-called ‘gas stations’ provide gloves at the pump for users to wear. However, the supply of gloves is not always maintained. Furthermore, germs can be spread by virtue of multiple persons reaching their hand into a box of gloves, thereby defeating their purpose. It is estimated that approximately two million bacteria, virus and other biological organisms can be picked up and remain on a person's palm and fingers with each contact of a non-sterile surface. Lastly, many glove materials—rubber, vinyl, latex, etc. can break down when exposed to natural elements such as rain and sunshine which again reduces their efficacy in reducing the spread of disease.

Accordingly, there exists an unmet need for a durable, compact, and accessible storage solution for sanitary gloves that protects them from contaminants, ensures usability over time, and integrates seamlessly with existing vehicle compartments.

### SUMMARY

In general, a pouch is provided that is configured to retain a plurality of gloves. The pouch is configured to be attached to the door that typically encloses the space around the fuel filler or tank refilling port that is used to fill fuel tanks on many types of automobiles, or inside of the fuel door compartment if there is sufficient space available in proximity to the fuel intake neck or tube.

In one exemplary embodiment, the pouch is configured to accommodate gloves that are folded flat to maximize the number of gloves that can be stored therewithin. In another exemplary embodiment, the pouch can be shaped to accommodate the fuel cap when the fuel filler access door is in the closed position. In another exemplary embodiment, the pouch includes an access seam that can be opened to retrieve one or more gloves and closed to store the gloves in a substantially air-tight environment. In another exemplary embodiment, the pouch can include indicia, such as a scannable QR code that a user can use to order additional gloves when the supply in the pouch is depleted or running low, or to order new pouches.

In a first general aspect, the invention relates to a method for preventing the transmission of disease from an automobile fuel dispensing or electric charging handle. The method includes providing a pouch comprising a front panel and a rear panel joined together along a left, right, and bottom perimeter edge of each of the front and rear panels, respectively. The pouch further comprises a flap portion integrally extending from the rear panel that is configured to fold over the front panel so as to allow the pouch to be reversibly opened and closed to access contents stored therein. The front panel, rear panel, and flap portion are solid and collectively form a substantially impervious enclosure that safeguards the contents of the pouch from external environmental elements when the pouch is in a closed configuration. Each of the front and rear panels has a length and width dimension selected such that the pouch can be adhered to an inner surface of a door of a fuel or electric charging access compartment of an automobile. The method further includes placing at least one single-use sanitary article within the pouch and attaching the pouch to the door using an adhesive or adhesive member disposed on the rear panel.

In some embodiments of the method, the flap portion includes a tab member, and the front panel includes a slot configured to receive the tab member, such that when the tab member is inserted into the slot, the flap portion is secured in a closed position by a mechanical interlock. The flap portion may exert an urging force against the front panel when the tab member is inserted into the slot, thereby enhancing the seal formed by the substantially impervious enclosure. In additional embodiments, the pouch may include a dispensing slot formed in the front panel and covered by an access strip removably adhered to the front panel. The access strip may selectively expose and seal the dispensing slot to protect the contents of the pouch. The dispensing slot may be located proximate to a top edge of the front panel and dimensioned to allow removal of a sanitary article while maintaining the substantially impervious enclosure for the remaining contents. In yet other embodiments, the front panel, rear panel, and flap portion may comprise a multi-layer construction including at least an outer protective layer, a middle vapor-barrier layer, and an inner layer configured to prevent chemical interaction with the sanitary articles stored therein. The adhesive or adhesive member may include a volatile organic compound (VOC)-neutralizing layer configured to absorb harmful vapors present within the access compartment, and the pouch may further comprise an activated charcoal filter disposed on an interior surface to neutralize vapors that may enter during opening.

In a second general aspect, the invention relates to a pouch for storing sanitary use articles. The pouch includes a first panel, and a second panel joined together along at least a portion of their respective perimeters to define an interior space configured to receive and retain a sanitary use article. The pouch further includes a closure mechanism configured to reversibly seal the interior space, wherein the first panel, second panel, and closure mechanism collectively form a substantially impervious enclosure that safeguards the contents of the pouch from external environmental elements when the pouch is in a closed configuration. The pouch also includes an attachment mechanism disposed on an exterior surface, operable to secure the pouch to a surface within an access compartment of an automobile.

In some embodiments of the pouch, the closure mechanism may include a fold-over portion extending from the second panel and configured to overlap the first panel. The fold-over portion may include a tab member, and the first panel may include a slot configured to receive the tab member, thereby securing the fold-over portion in a closed position. The fold-over portion may exert an urging force against the first panel when the tab member is inserted into the slot, enhancing the seal formed by the substantially impervious enclosure. In other embodiments, the first panel, second panel, and closure mechanism may include a multi-layer construction comprising an outer protective layer, a vapor-barrier layer, and an inner layer configured to prevent chemical interaction with the sanitary articles. The attachment mechanism may include an adhesive patch with a VOC-neutralizing layer configured to absorb harmful vapors within the access compartment, and the pouch may further include an activated charcoal filter disposed on an interior surface to neutralize vapors that may enter during opening.

In further embodiments, the pouch may include additional design features to enhance its functionality. For instance, the closure mechanism may comprise a dispensing slot positioned near the top edge of the pouch and configured to allow removal of sanitary articles while protecting the remaining contents. In other embodiments, the pouch may be configured for compatibility with various attachment mechanisms, including adhesive patches, hook-and-loop fasteners, or brackets, allowing flexibility in securing the pouch within an access compartment or other locations.

In some configurations, the pouch includes features for enhanced durability and usability in challenging environments. The pouch may include layers of protective material designed to shield its contents from exposure to contaminants, such as gas vapors, moisture, or dust. This ensures that the pouch is effective across a variety of applications, whether used in automotive access compartments or other storage environments requiring sanitary precautions.

Certain advantages of the systems and methods include the ability to provide a source of sanitary use gloves for use when refueling a vehicle; reduction in transmission of disease by protecting users from unclean, or unsanitary fuel dispensing handles; and providing a simple method of restocking gloves when the supply is depleted or diminished; among others.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting. In case of conflict with terms used in the art, the present specification, including definitions, will control.

The foregoing summary is illustrative only and is not intended to be in any way limiting. In addition to the illustrative aspects, embodiments, and features described above, further aspects, embodiments, and features will become apparent by reference to the drawings and the following detailed description and claims.

### DESCRIPTION OF DRAWINGS

The present embodiments are illustrated by way of the figures of the accompanying drawings, which may not necessarily be to scale, in which like references indicate similar elements, and in which:

FIG. 1 illustrates a storage pouch for sanitary use articles, and a method of its use, according to one embodiment;

FIG. 2 is a storage pouch for sanitary use articles according to one embodiment, shown adhered to a fuel tank access door of a prior art vehicle;

FIG. 3 shows a front-side view of the storage pouch for sanitary use articles of FIG. 2;

FIG. 4 shows a rear-side view of the storage pouch for sanitary use articles of FIG. 2;

FIG. 5 shows a side view of the storage pouch for sanitary use articles of FIG. 2;

FIG. 6 illustrates a pouch according to a second illustrative embodiment;

FIG. 7 illustrates a pouch according to a third illustrative embodiment;

FIG. 8 illustrates a pouch according to a fourth illustrative embodiment;

FIG. 9 illustrates a pouch according to a fifth illustrative embodiment and a method for its use;

FIG. 10 is a top-plan view of the pouch of FIG. 7 according to one embodiment; and

FIG. 11 illustrates a pouch having multi-layered walls, according to one embodiment.

### DETAILED DESCRIPTION OF ILLUSTRATIVE EMBODIMENTS

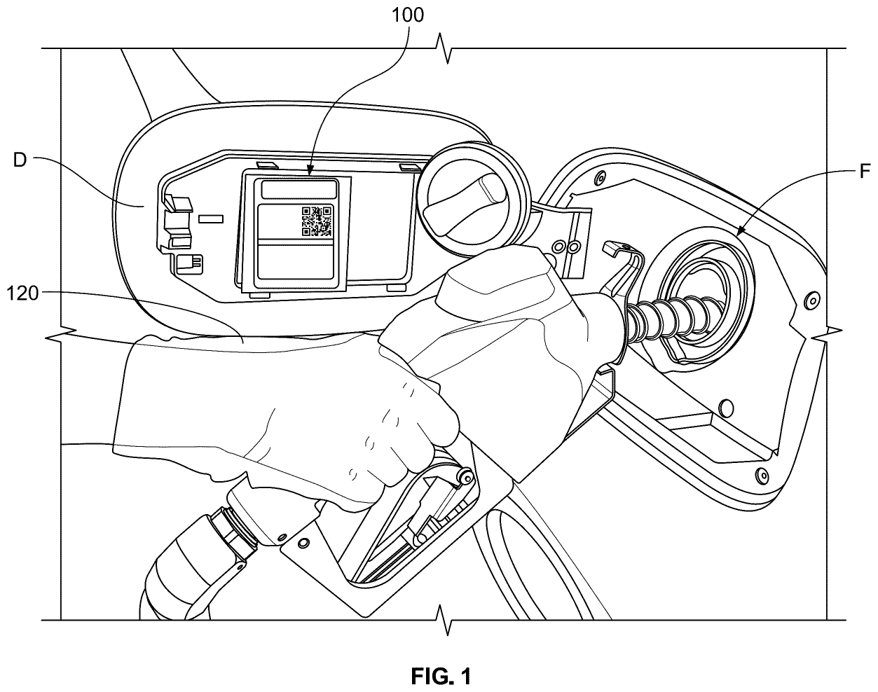

FIG. 1 shows a storage pouch for sanitary use articles (hereinafter ‘pouch’) 100 adhered to an access door D of a fuel filler port F of a vehicle. In this and other embodiments pouch 100 is configured to retain a plurality of protective gloves 120 that are made available to the operator when the access door D is opened. Gloves 120 can protect the operator from communicable diseases such as, but not limited to the Covid-19 virus, and other germs. Gloves 120 additionally protect the operator's hand from dirt and other material that may be present on the fuel pump handle. The gloves 120 can preferably be sanitary use gloves such as, but not limited to latex or non-latex (e.g., latex, nitrile rubber, polyvinyl chloride or neoprene) gloves. In a preferred embodiment, the gloves 120 are relatively thin, so as to maximize the number of gloves that can fit within pouch 100 without significant bulging.

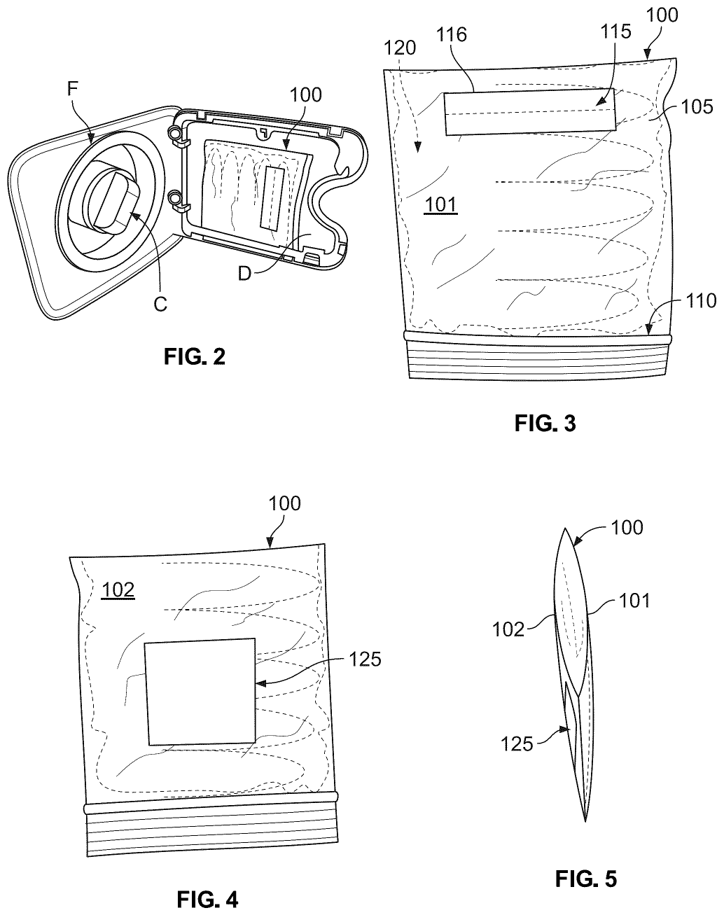

FIGS. 2-4 show an unobstructed view of the pouch 100 in relation to the fuel filler port F of a vehicle. In this and other embodiments, the pouch 100 can be adhered to the inside of access door D such that when the door D is in a closed configuration, the pouch 100 is concealed and confronts, or becomes proximate to cap C, which, in this example, is connected to fuel filler port F.

In this embodiment, pouch 100 includes a front side 101 (FIG. 3) and an opposite rear side 102 (FIG. 4). In this embodiment, the pouch 100 includes a main access 110 that allows the front (101) and rear (102) sides to be reversibly interlocked, e.g., opened and closed. In this example, the main access 110 is similar to the closure system of bags sold under the ZIPLOC® brand.

In this embodiment, the front side 101 includes a dispensing slot 115 illustrated as a dashed line in FIG. 3 to indicate its presence beneath an access strip 116. The dispensing slot 115 is, in this embodiment, a slot within the front side 101 that allows a glove to be removed from the pouch 100. The access strip 116 can be one that initially seals the pouch 100 but can be peeled away to expose the dispensing slot 115 before the pouch 100 is placed into use. In one embodiment, the access strip 116 can be one that is reversibly-removed, so that the access strip 116 can be replaced after a glove is removed from the dispensing slot 115 of the pouch 100.

Referring in particular now to FIG. 4, in this embodiment, the pouch 100 is configured to be adhered to the door D that encloses the fuel filler F of an automobile utilizing an adhering patch 125. In this embodiment, patch 125 includes adhesives on front and rear surfaces, such that it can be adhered to both the pouch 100 and the door D. It should be understood that the patch 125 shown and described in this embodiment is but one of many approaches that can be used to adhere the pouch 100 to the door D, such as by use of hook-and-loop fastening systems, double-sided adhesives, tapes, etc.

Referring now to FIG. 5, a side-view of the pouch 100 is shown to illustrate the overall width of the pouch 100. In many, but not all instances, it can be preferable to maintain the width of the pouch such that it does not interfere with the closure of door D or any ventilation characteristics or features of the gas cap C or fuel port F. In one embodiment, pouch 100 is configured to retain about 4 gloves, e.g., 2, 3, 4, 5 or 6 gloves; however, it should be understood that the thickness of the glove material can affect the overall width of the pouch 100, such that more or fewer gloves may be accommodated. For example, the pouch can be configured to store 2, 3, 4, 5, 6, 7, 8 . . . up to 20 gloves. In one embodiment, the pouch 100 is configured to retain a number of gloves such that the width of the pouch 100 is about one-quarter of an inch. In this and other embodiments, a functional criticality can include limiting the number of gloves per pouch such that the overall width of the pouch does not preclude normal functioning of the fuel door D or fuel cap C.

In use, the pouch may first be filled with a desired number and type of glove, such as a sanitary use glove. The pouch can be filled by opening the main access 110 and inserting the gloves within the pouch, followed by closing, or resealing the main access 110. As described above, in other embodiments, the periphery of the front (101) and rear (102) sides can be sealed together, thereby enclosing a selected number of gloves. In such an embodiment, a main access 110 is alternatively unused.

Next, patch 125 can be used to adhere the rear surface 102 of pouch 100 onto door D so that the front surface 101 is facing outward as shown. Next, the door D can be closed, and the vehicle operated as usual. When it is time for the vehicle to be refueled, the user can open door D as usual and remove or peel back access strip 116 to expose dispensing slot 115. One or more gloves 120 may be removed through the dispensing slot 115 which can be donned by the user. The user may then dispense fuel into their vehicle as usual, using the glove to protect him from germs existing on the fuel dispenser handle. If the access strip 116 is of the reusable type, it may be replaced over the dispensing slot 115 to keep the contents of the pouch 100 clean and protected. The dispensing slot 115 may also include configurations such as flaps, zippers, or resealable adhesives to suit different operational or manufacturing needs.

In one embodiment, indicia may be printed on a surface of the pouch 100. The indicia may include advertising material or other indicia. In one exemplary embodiment, the indicia may include a QR (quick response) code printed on the inside surface of the rear side 102. The QR code may preferably be encoded for use by a mobile electronic device such as a cellular telephone to direct a user to a website or other digital portal whereby more gloves 120 or pouch(es) 100 may be ordered by a user.

In one embodiment, a colored glove (e.g., a pink or blue glove) may be inserted into the series of gloves 120 within the pouch 100. In particular, the colored glove can be placed within the series of gloves such that it serves as a reminder that the quantity of gloves is low and a new pouch 100 needs to be ordered.

In an example, gloves may be stacked and placed within the pouch 100 such that there exists a first glove, a number of intervening gloves, and a last glove in the stack. A colored glove may be placed, e.g., one- or two positions in the stack before the last glove would normally be extracted from the pouch.

In an alternative embodiment, a card or other piece of printable material may be inserted into the pouch 100, within the plurality of gloves 120, but near to the rear side 102, so that the card or printable material is exposed when the number of gloves remaining in the pouch is low, e.g., between 2-3 gloves remaining. The card or printable material may similarly include encoded—as in the case of a QR code—or unencoded indicia providing the user a digital avenue by which to order additional gloves 120 or pouch(es) 100 already pre-filled with gloves 120.

In an alternative embodiment, a bracket member (not shown in the drawings) configured to support a pouch 100 can be affixed to the inner surface of door D, thereby alleviating the need for patch 125. In such an embodiment, the bracket member can be small enough to be affixed onto door D without interfering with the action of the door or the fuel cap C. The bracket member can be configured to allow an empty pouch to be swapped for a new pouch (containing a full allotment of gloves) easily and quickly.

It should be understood that pouch 100 is exemplary and that other types of pouches and containers can be alternatively used for holding sanitary articles.

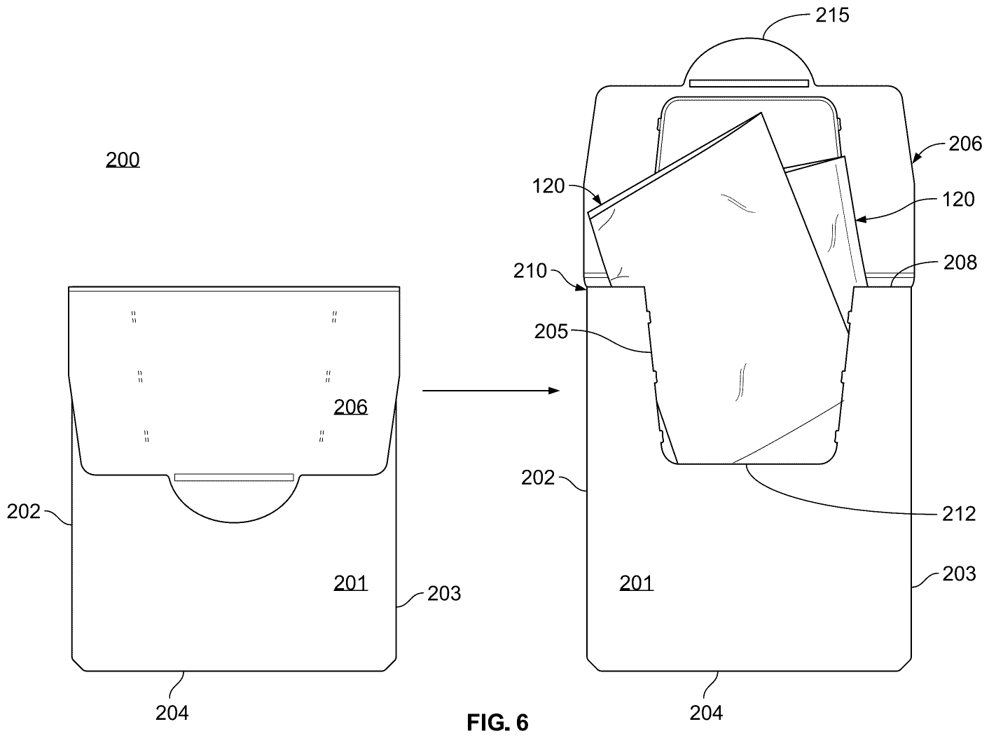

For example, referring to FIG. 6, pouch 200 includes a front side 201, a rear side 210 opposite the front side 201, a left side 202, a right side 203, and a bottom side 204. The pouch 200 further includes a U-shaped cut-out 205 on the front side 201. The rear side 210 includes a fold-over portion 206 extending therefrom configured to reversibly fold over a top portion 208 of the front side 201 and a tab member 215 of the fold-over portion 206 configured to tuck into a bottom portion 212 of the U-shaped cut-out 205. The pouch 200 further includes an adhesive disposed on the rear side 210 of the storage pouch. Gloves 120 are stored within the pouch 200, and the pouch 200 is configured to be adhered, by way of the adhesive, to an inner portion of a fuel door of a vehicle, such that when the fuel door is closed, the storage pouch is concealed from view.

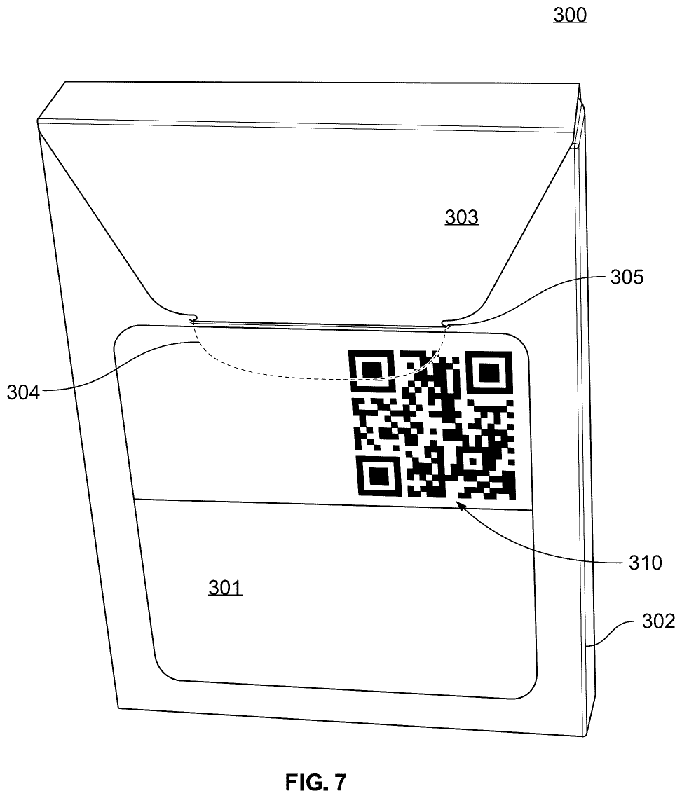

FIG. 7 illustrates a pouch 300 having a front side 301 and a rear side 302 opposite the front side, a fold-over portion 303 extending from the rear side 302, and a tab member 304 extending from the fold-over portion 303. The front side 301 includes a slot 305 for receiving the tab member 304, thereby providing a way to keep the fold-over portion 303 closed. An adhesive can be disposed on the rear side 302 to allow the pouch 300 to be placed inside a fuel door chamber and concealed from view. A QR code 310 provides an encoded hyperlink, accessible using, for example, a smart phone or other device capable of reading QR codes, that can lead a user to a website, ecommerce site, or other location on the Internet for ordering pouches.

In this and other embodiments, such as pouch 100, 200, 300 and 400, the pouch 300 inherently minimizes the ingress of contaminants such as gas vapors, dust, and moisture when in its closed configuration. For example, referring to pouch 300 (FIG. 7), the overlapping fold-over portion 303 provides a naturally effective barrier by aligning tightly with the front side 301. This overlapping structure reduces the size of any potential gaps through which contaminants might enter, leveraging the close contact between the fold-over portion and the pouch body to shield the interior environment where a plurality of gloves 120 can be stored.

In this and other embodiments disclosed herein, the structural integrity of the pouch material can further contribute to its protective characteristics. For example, the pouch 300 can be fabricated from materials with low permeability to gas and vapor, such as polyethylene or polypropylene blends. These materials inherently resist penetration by volatile organic compounds (VOCs) and other airborne contaminants, ensuring that the interior remains clean and uncontaminated. The smooth, dense surfaces of these materials create a barrier that is highly effective even in the absence of supplementary sealing components.

Moreover, the design of the tab member 304 and the slot 305 enhances the pouch's natural resistance to contamination. When the tab is inserted into the slot, the mechanical interlock creates a continuous line of contact that serves as a primary defense against contaminants. This configuration ensures that any gaps are sufficiently narrow to prevent significant ingress of particulate matter or vapors, especially when the pouch is stored within the relatively enclosed environment of a fuel door compartment. In this and other embodiments, the tab member 304 and slot 305 cooperate to maintain the fold-over portion 303 securely in place by creating an interlocking mechanism that resists unintended opening. When the tab is inserted into the slot, the natural resilience of the fold-over portion 303 exerts an urging force downward against the top of the container body, enhancing the closure's stability and ensuring that the pouch remains tightly sealed against external environmental elements.

In some embodiments, the geometry of the fold-over portion 303 can be optimized to create a natural downward slope when closed. This slope encourages any liquid contaminants, such as fuel drips or condensation, to flow away from the pouch opening rather than pooling near the closure. This passive design element reduces the likelihood of liquid intrusion and enhances the overall durability of the pouch.

These design elements collectively provide significant protection for the gloves 120 stored within the pouch, ensuring they remain uncontaminated and ready for use. Importantly, these protective features do not rely on additional components such as gaskets, making the pouch simpler and more cost-effective to manufacture while still offering reliable performance.

However, in this and other embodiments (such as pouches 100, 200, 400), the pouch 300 can be specifically designed to create a substantially impervious barrier to environmental contaminants, including gas vapors, moisture, and particulate matter, thereby protecting the integrity of gloves 120 stored within. As used herein, “substantially impervious” refers to the ability of the pouch to significantly limit or prevent the ingress of environmental contaminants, such as gas vapors, moisture, and particulates, under normal operating conditions, thereby safeguarding the integrity of the gloves stored within.

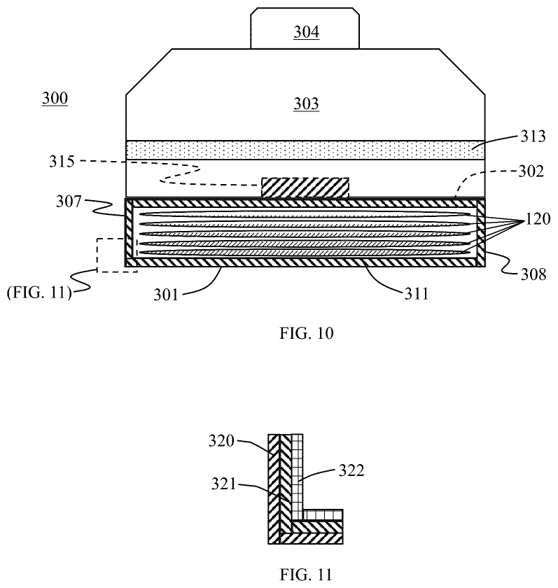

For example, referring to FIG. 10, a top-plan view of the pouch 300 shown in FIG. 7, the fold-over portion 303 of the pouch 300 can be configured with a specialized sealing mechanism that not only secures the tab member 304 within slot 305 but also compresses an integrated gasket 311 along the closure seam. This gasket 311 can be made, e.g., from a flexible elastomeric material, ensuring an airtight and watertight seal when the pouch is closed. Such a configuration minimizes the ingress of volatile organic compounds (VOCs) commonly present in the vicinity of fuel compartments, which could otherwise degrade the material of the gloves or reduce their efficacy.

Additionally, referring to FIG. 11, in this and other embodiments the pouch 300 may incorporate a multi-layer construction, in particular for its front side 301, rear side 302, left side 307 and right side 308. In one embodiment, these layers include includes an outer protective polymer layer 320, a middle vapor-barrier layer 321 composed of aluminum foil or a similar impermeable material, and an inner layer 322 of soft, glove-safe polymer that prevents any chemical interaction with the gloves. This multi-layer design ensures that external contaminants such as fuel vapors or fine dust cannot permeate the pouch walls, offering extended durability for the gloves stored inside. In one embodiment, the pouch 300 can integrate accordion-style sidewalls, e.g., left side 307 and right side 308, allowing for adjustable width while maintaining structural integrity during use.

In this and other embodiments, to further safeguard against contamination, a desiccant packet can be affixed to the interior surface of the pouch, e.g., to the interior surface of the rear side 302. The desiccant can actively absorb any residual moisture that may enter during glove retrieval, maintaining a dry environment conducive to the longevity of the gloves. Similarly, an optional activated charcoal filter 313 may be integrated into, or attached onto the interior of the pouch, e.g., on the interior portion of fold-over portion 303. The filter can capture and neutralize VOCs and other harmful gases that might enter the pouch during the brief intervals when the pouch is opened.

In this and other embodiments, the attachment of the pouch 300 within the fuel compartment can also be designed to enhance the protective capabilities of the gloves 120 stored therein. For instance, an adhesive patch 315 with a VOC-neutralizing layer may be used. This layer can absorb harmful vapors emitted from the surrounding fuel cap area, ensuring that the immediate vicinity of the pouch remains uncontaminated. Additionally, the placement of the pouch 300 on the inner surface of the fuel door is optimized to shield it from direct exposure to residual fuel drips or splashes during refueling.

The protective measures described above are applicable not only to the embodiment shown in FIGS. 7, 10 and 11, but also to other embodiments of the pouch disclosed herein. For example, in embodiments with reversible main access systems (e.g., zippers, press-and-seal mechanisms), the addition of gasketed closures or multi-layer pouch materials can similarly provide enhanced protection. These configurations ensure that the gloves remain sterile and ready for use, even in challenging environmental conditions.

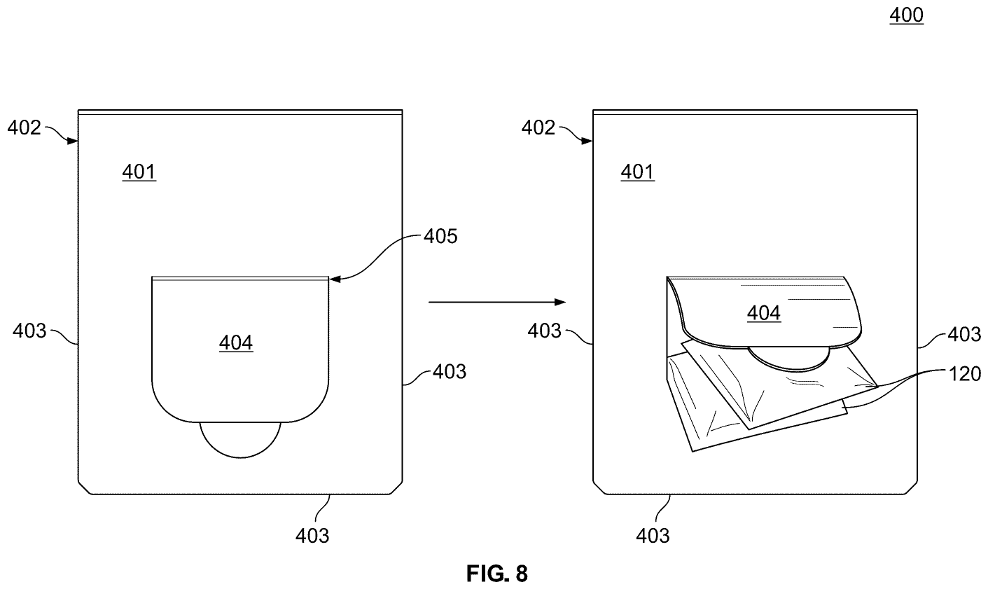

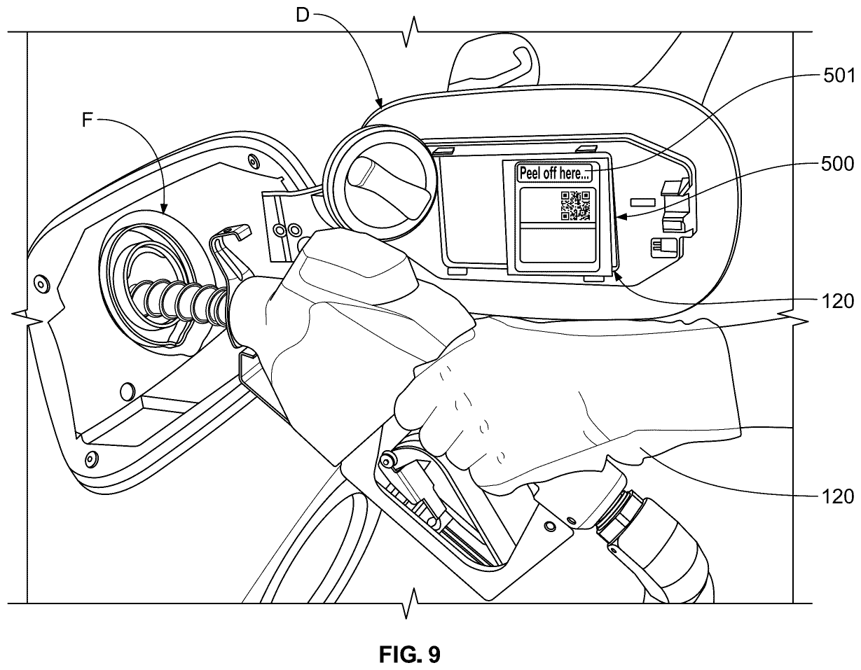

FIG. 8 illustrates a pouch 400 having front (401) and rear (402) sides. In this embodiment, the front (401) and rear (402) sides are joined at their respective circumferential edges 403, thereby forming a flat pouch. In this embodiment, an access door 404 capable of being folded up and down about a seam 405 is disposed on the front side 401, thereby allowing access to gloves 120 when needed.

FIG. 9 illustrates a pouch 500 adhered to the inner portion of a fuel door F. In this embodiment, the pouch 500 is formed of a plastic material and configured so as to retain a number of gloves 120. In this embodiment, the pouch includes a reversibly-sealable, fold-over top portion 501 that allows the pouch 500 to be opened and closed as desired to remove a glove 120 for use.

A number of illustrative embodiments have been described. Nevertheless, it will be understood that various modifications may be made without departing from the spirit and scope of the various embodiments presented herein. For example, while the present description has referenced a fuel door F of a petroleum-powered automobile, it should be understood that the concepts equally apply to other access doors such as those used on electric vehicles and the like. In certain embodiments, a pouch of the type described herein may be stored on other parts of an automobile, such as within a glove compartment box, on or under a dashboard, etc. Accordingly, other embodiments are within the scope of the following claims.

What is claimed is:

1. A method for preventing the transmission of disease from an automobile fuel dispensing or electric charging handle, comprising:
providing a pouch comprising a front panel and a rear panel joined together along a left, right and bottom perimeter edge of each of said front and said rear panels, respectively;
wherein said pouch further comprises a flap portion integrally extending from said rear side panel that is configured to fold over said front panel so as to allow said pouch to be reversibly opened and closed to access contents stored therein;
wherein said front panel, said rear panel, and said flap portion are solid and form an a substantially impervious enclosure that safeguards the contents of the pouch from external environmental elements when said pouch is in a closed configuration;
wherein each of said front panel and said rear panel of said pouch each has a length and width dimension that is selected such that said pouch can be adhered to an inner surface of a door of a fuel or electric charging access compartment of said automobile;
placing at least one single use sanitary article within said pouch; and
placing an adhesive or an adhesive member on said rear side of said panel operable to hold said pouch at a selected location on said inner surface of said door of said fuel or electric charging access compartment.

2. The method of claim 1, wherein said flap portion includes a tab member and said front panel includes a slot configured to receive said tab member, such that when said tab member is inserted into said slot, said flap portion is maintained in a closed position by a mechanical interlock.

3. The method of claim 2, wherein said flap portion exerts an urging force against said front panel when said tab member is inserted into said slot, thereby enhancing the seal formed by said substantially impervious enclosure.

4. The method of claim 1, wherein said pouch further comprises an access strip that is removably adhered to said front panel and is configured to cover a dispensing slot formed in said front panel, said access strip operable to be removed and replaced to selectively expose or seal said dispensing slot.

5. The method of claim 4, wherein said dispensing slot is located proximate to a top edge of said front panel and is dimensioned to allow removal of said at least one single use sanitary article from said pouch while maintaining the substantially impervious enclosure of the remaining contents.

6. The method of claim 1, wherein said pouch further comprises a multi-layer construction including at least an outer protective layer, a middle vapor-barrier layer, and an inner layer configured to prevent chemical interaction with said at least one single use sanitary article.

7. The method of claim 1, wherein said adhesive member comprises a patch with a volatile organic compound (VOC)-neutralizing layer configured to absorb harmful vapors present within said fuel or electric charging access compartment.

8. The method of claim 7, wherein said VOC-neutralizing layer comprises activated charcoal or another adsorbent material, and said pouch further comprises an activated charcoal filter disposed on an interior surface of said pouch to capture vapors that may enter during opening.

9. A pouch for preventing the transmission of disease from an automobile fuel dispensing or electric charging handle, comprising:
a front panel and a rear panel joined together along a left, right, and bottom perimeter edge of each of said front and said rear panels, respectively;
a flap portion integrally extending from said rear panel and configured to fold over said front panel, wherein said flap portion is operable to reversibly open and close to provide access to an interior of said pouch;
wherein said front panel, said rear panel, and said flap portion are solid and collectively form a substantially impervious enclosure that safeguards contents of the pouch from external environmental elements when said pouch is in a closed configuration;
wherein said front panel and said rear panel each have a length and width dimension selected such that said pouch is sized to be adhered to an inner surface of a door of a fuel or electric charging access compartment of an automobile; and
an adhesive or adhesive member disposed on an outer surface of said rear panel, said adhesive or adhesive member operable to secure said pouch to said inner surface of said door.

10. The pouch of claim 9, wherein said flap portion includes a tab member, and said front panel includes a slot configured to receive said tab member, such that when said tab member is inserted into said slot, said flap portion is secured in a closed position by a mechanical interlock.

11. The pouch of claim 10, wherein said flap portion exerts an urging force against said front panel when said tab member is inserted into said slot, thereby enhancing the seal formed by said substantially impervious enclosure.

12. The pouch of claim 9, further comprising a dispensing slot formed in said front panel and an access strip removably adhered to said front panel, said access strip configured to selectively expose and seal said dispensing slot.

13. The pouch of claim 12, wherein said dispensing slot is positioned proximate to a top edge of said front panel and is dimensioned to allow removal of a sanitary article from said pouch while maintaining the substantially impervious enclosure for the remaining contents.

14. The pouch of claim 9, wherein said front panel, rear panel, and flap portion each comprise a multi-layer construction, said multi-layer construction including at least an outer protective layer, a middle vapor-barrier layer, and an inner layer configured to prevent chemical interaction with the sanitary articles stored therein.

15. The pouch of claim 9, wherein said adhesive or adhesive member includes a patch having a volatile organic compound (VOC)-neutralizing layer configured to absorb harmful vapors within said fuel or electric charging access compartment.

16. The pouch of claim 15, wherein said VOC-neutralizing layer comprises activated charcoal or a similar adsorbent material, and said pouch further comprises an activated charcoal filter disposed on an interior surface of said pouch to neutralize vapors that may enter during opening.

17. A pouch for storing sanitary use articles, comprising:
a first panel and a second panel joined together along at least a portion of their respective perimeters to define an interior space configured to receive and retain a sanitary use article;
a closure mechanism configured to reversibly seal said interior space, wherein said first panel, said second panel, and said closure mechanism collectively form a substantially impervious enclosure that safeguards the contents of the pouch from external environmental elements when said pouch is in a closed configuration; and
an attachment mechanism disposed on an exterior surface of said pouch, said attachment mechanism operable to secure said pouch to a surface within an access compartment of an automobile.

18. The pouch of claim 17, wherein said closure mechanism comprises a fold-over portion extending from said second panel and configured to overlap said first panel, said fold-over portion including a tab member and said first panel including a slot configured to receive said tab member, thereby securing said fold-over portion in a closed position.

19. The pouch of claim 17, wherein said first panel, said second panel, and said closure mechanism comprise a multi-layer construction including an outer protective layer, a vapor-barrier layer, and an inner layer configured to prevent chemical interaction with the sanitary use articles stored therein.

20. The pouch of claim 17, wherein said attachment mechanism comprises an adhesive patch with a volatile organic compound (VOC)-neutralizing layer operable to absorb harmful vapors present in said access compartment of said automobile.
